(19) United States
(12) Patent Application Publication
(10) Pub. No.: US 2021/0306471 A1
(43) Pub. Date: Sep. 30, 2021

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJIFILM Business Innovation Corp., Tokyo (JP)

(72) Inventor: Jo SUDA, Kanagawa (JP)

(73) Assignee: FUJI XEROX CO., LTD., Tokyo (JP)

(21) Appl. No.: 16/941,550

(22) Filed: Jul. 29, 2020

(30) Foreign Application Priority Data
Mar. 26, 2020 (JP) 2020-056634

(51) Int. Cl. H04N 1/00; G06F 8/65

(52) U.S. Cl. CPC H04N 1/0097; H04N 1/00973; G06F 8/65; H04N 1/00034; H04N 1/00082; H04N 1/0001

(57) ABSTRACT

An information processing apparatus includes a processor configured to, upon distribution of a firmware to plural target apparatuses connected to a predetermined communication network, divide in advance and hold the firmware into a predetermined number of pieces of divided firmware; and distribute the pieces of divided firmware to each of the plural target apparatuses with the pieces divided into distribution number of divisions set for the target apparatus.

### CROSS-REFERENCE TO RELATED APPLICATIONS

This application is based on and claims priority under 35 USC 119 from Japanese Patent Application No. 2020-056634 filed on Mar. 26, 2020.

### BACKGROUND

### (i) Technical Field

The present disclosure relates to an information processing apparatus, an information processing system, and a non-transitory computer readable medium storing a program.

### (ii) Related Art

Japanese Unexamined Patent Application Publication No. 2016-206858 proposes an image forming apparatus that, when transmitting information to a management server, determines an estimated band for a network, selects information to be transmitted based on the estimated band, divides the information into pieces based on a priority, and transmits a piece of information with a high priority quickly and reliably.

### SUMMARY

When a firmware is transmitted based on an estimated band of communication, even if transmission is possible through the estimated band, no margin in the entire band may cause congestion in a communication band and a difficulty in communication work. Aspects of non-limiting embodiments of the present disclosure relate to an information processing apparatus, an information processing system, and a non-transitory computer readable medium storing an information processing program that are capable of reducing the load of a communication network when a firmware is distributed, as compared with when the firmware is collectively transmitted based on an estimated band of communication.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to upon distribution of a firmware to a plurality of target apparatuses connected to a predetermined communication network, divide in advance and hold the firmware into a predetermined number of pieces of divided firmware; and distribute the pieces of divided firmware to each of the plurality of target apparatuses with the pieces divided into distribution number of divisions set for the target apparatus.

### BRIEF DESCRIPTION OF THE DRAWINGS

Exemplary embodiment of the present disclosure will be described in detail based on the following figures, wherein:

FIG. 1 is a diagram illustrating the schematic configuration of an information processing system according to an exemplary embodiment;

FIG. 2 is a block diagram illustrating the configuration of an electric system of an image forming apparatus according to the exemplary embodiment;

FIG. 3 is a block diagram illustrating the configuration of electrical systems of a cloud server for LGWAN-ASP infrastructure and an EP system according to the exemplary embodiment;

FIG. 4 is a flowchart illustrating an example of flow of processing performed at the time of distribution setting for the image forming apparatus in the information processing system according to the exemplary embodiment;

FIG. 5 is a table illustrating an example of a user management table;

FIG. 6 is a screen illustrating an example of a FW distribution setting screen;

FIG. 7 is a flowchart illustrating an example of flow of processing performed when the cloud server for LGWAN-ASP infrastructure in the information processing system according to the exemplary embodiment receives notification of each setting item from the image forming apparatus;

FIG. 8 is a table illustrating an example of a distribution time master;

FIG. 9 is a table illustrating an example of a distribution priority master;

FIG. 10 is a table illustrating an example of a distribution division master;

FIG. 11 is a chart illustrating an example of details of notification of a result of update processing;

FIG. 12 is a flowchart illustrating an example of flow of processing performed when the cloud server for LGWAN-ASP infrastructure in the information processing system according to the exemplary embodiment distributes a FW to the image forming apparatus;

FIG. 13 is a table illustrating an example of a FW latest version master;

FIG. 14 is a table illustrating an example of target FW automatic contract for ◯◯◯3100;

FIG. 15 is a table illustrating an example of a contract/machine table;

FIG. 16 is a table illustrating an example of a machine distribution setting table;

FIG. 17 is a table illustrating an example of a FW repository management master;

FIG. 18 is a table illustrating an example of a number of divisions setting table in which the number of divisions is predetermined for every FW distribution time;

FIG. 19 is a table illustrating an example of a number of divisions setting table in which the number of divisions is predetermined for every retransmission timeout time; and

FIG. 20 is a table illustrating an example of a number of divisions setting table in which the number of divisions is predetermined according to a priority.

### DETAILED DESCRIPTION

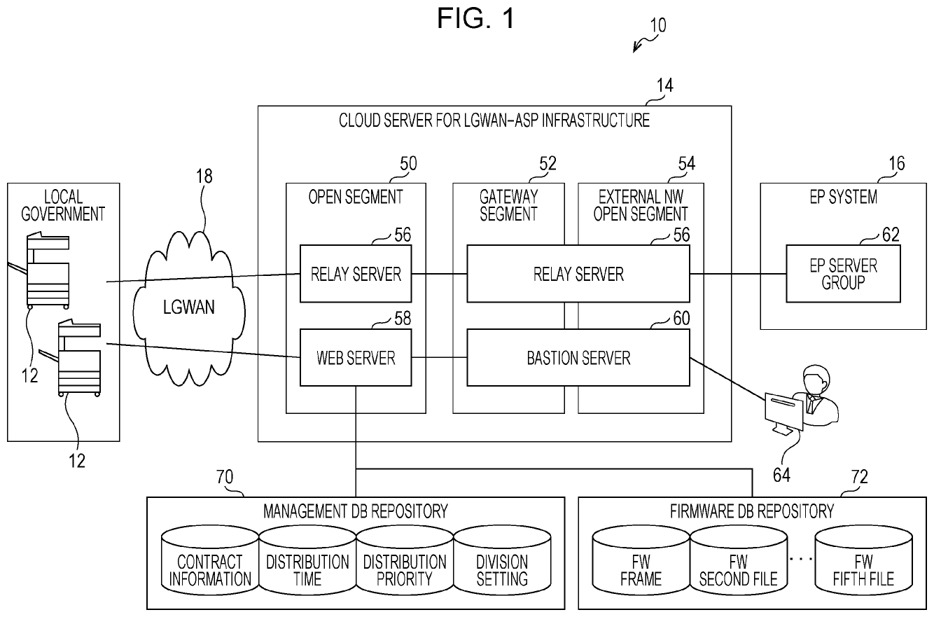

Hereinafter, an example of an exemplary embodiment of the present disclosure will be described in detail with reference to the drawings. FIG. 1 is a diagram illustrating the schematic configuration of an information processing system according to an exemplary embodiment.

As illustrated in FIG. 1, an information processing system 10 according to the exemplary embodiment includes multiple image forming apparatuses 12, a cloud server 14 for local government wide area network (LGWAN)-application service provider (ASP) infrastructure, and an electronic partnership (EP) 16.

Each image forming apparatus 12 is connected via a LGWAN 18 as a communication network to the cloud server 14 for (LGWAN)-(ASP) infrastructure which is connected to the EP system 16. It is to be noted that LGWAN is a network for administration, which connects local networks to each other.

The cloud server 14 for (LGWAN)-(ASP) infrastructure is a cloud server that provides an ASP service for a local government as a cloud service. The cloud server 14 for (LGWAN)-(ASP) infrastructure has a three-layer structure including an open segment 50, a gateway segment 52, and an external network (NW) open segment 54. Each segment is provided with the function of a relay server 56 that provides coordination between segments. The relay server 56 connects an EP server group 62 included in the EP system to the LGWAN 18 via the segments. In addition, the open segment 50 is provided with the function of a world wide web (WEB) server 58 which has a function of storing and distributing a firmware (FW) of each image forming apparatus 12. The gateway segment 52 and the external NW open segment 54 are provided with the function of a bastion server 60 which is connected to an information processing terminal 64 of an EP administrator.

The web server 58 is connected to a management database (DB) repository 70, and a firmware DB repository 72. The management DB repository 70 stores information, such as contract information, a distribution time of a firmware, a distribution priority, and division setting when a firmware is distributed. The firmware DB repository 72 pre-stores a FW to be distributed to each image forming apparatus with the FW divided into a predetermined number of pieces of division FW. In the exemplary embodiment, an example will be described, in which each FW is stored with the FW divided into five sections of a FW frame, a FW second file, . . . a FW fifth file. However, the number of divisions is not limited to this. For distribution of a FW, the web server 58 performs the distribution according to a distribution priority and a division specification using management DB repository 70.

The EP system has functions of collecting, summarizing, and analyzing data from the image forming apparatus 12, and providing coordination with each service.

The image forming apparatus 12 is connected to a communication network in a local government to allow distribution conditions for each FW to be set. As a distribution condition, for instance, FW distribution times (for instance, 0:00-6:00, 6:00-12:00, 12:00-18:00, 18:00-24:00) can be set. In addition, a distribution priority (for instance, high, medium, low) can be set as a distribution condition. In addition, the image forming apparatus 12 allows FW distribution setting in a collective or divided manner (for instance, 2 times, 3 times, 4 times, 5 times) as a distribution condition.

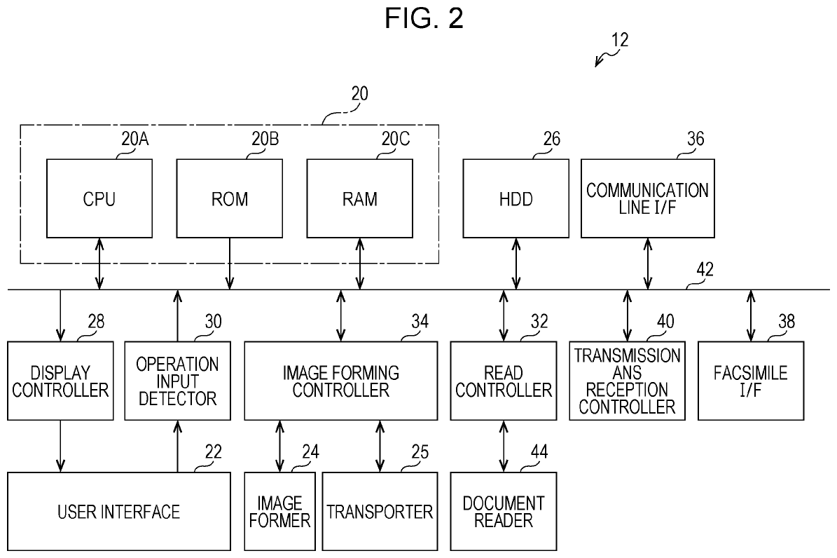

FIG. 2 is a block diagram illustrating the configuration of an electric system of the image forming apparatus 12 according to the exemplary embodiment.

As illustrated in FIG. 2, the image forming apparatus 12 according to the exemplary embodiment includes a control unit 20 including a central processing unit (CPU) 20A, a read only memory (ROM) 20B, and a random access memory (RAM) 20C. The CPU 20A supervises the entire operation of the image forming apparatus 12. The RAM 20C is used as a work area or the like when various programs are executed by the CPU 20A. The ROM 20B pre-stores various control programs and various parameters. In the image forming apparatus 12, the components of the control unit 20 are electrically connected to each other by a system bus 42.

Meanwhile, the image forming apparatus 12 according to the exemplary embodiment includes a hard disc drive (HDD) 26 that stores various types of data such as various types of information and application programs, related to user information, setting parameters, and coordination services. In addition, the image forming apparatus 12 includes a display controller 28 which is connected to a user interface 22 and controls the display of various operation screens on a display of the user interface 22. In addition, the image forming apparatus 12 includes an operation input detector 30 which is connected to the user interface 22 and detects an operational instruction inputted via the user interface 22. In the image forming apparatus 12, the HDD 26, the display controller 28, and the operation input detector 30 are electrically connected to the system bus 42. It is to be noted that although the HDD 26 is used as a storage in the image forming apparatus 12 according to the exemplary embodiment, without being limited to this, a non-volatile storage, such as a flash memory, may be used.

The image forming apparatus 12 according to the exemplary embodiment includes a read controller 32 that controls an optical image read operation by a document reader 44 and a document feed operation by a document feeder; and an image forming controller 34 that controls the image forming processing performed by an image former 24 and the transport of a sheet of paper to the image former 24 by a transporter 25. The image forming apparatus 12 includes a communication line interface (IF) 36 which is connected to the LGWAN 18 to transmit and receive communication data to and from an external apparatus, such as the cloud server 14 for (LGWAN)-(ASP) infrastructure connected to the LGWAN 18. The image forming apparatus 12 includes a facsimile interface (IF) 38 which is connected to a phone line (not illustrated) and transmits and receives facsimile data to and from a facsimile device connected to the phone line. In addition, the image forming apparatus 12 includes a transmission and reception controller 40 that controls the transmission and reception of facsimile data via the facsimile IF 38. In the image forming apparatus 12, the transmission and reception controller 40, the read controller 32, the image forming controller 34, the communication line IF 36, and the facsimile IF 38 are electrically connected to the system bus 42.

With the configuration described above, the image forming apparatus 12 according to the exemplary embodiment makes access to each of the RAM 20C, the ROM 20B, and the HDD 26 by the CPU 20A. The image forming apparatus 12 controls the display of an operation screen on a display of the interface 22 and of information such as various messages by the CPU 20A. The image forming apparatus 12 controls the operation of the document reader 44 and a document transporter via the read controller 32 by the CPU 20A. In addition, the image forming apparatus 12 controls the operation of the image former 24 and the transporter 25 via the image forming controller 34 and controls the transmission and reception of communication data via the communication line IF 36 by the CPU 20A. The image forming apparatus 12 controls the transmission and reception of facsimile data via the facsimile IF 38 by the transmission and reception controller 40. In addition, the image forming apparatus 12 recognizes an operational detail of the user interface 22 based on the operation information detected by the operation input detector 30, and performs various control based on the operational detail.

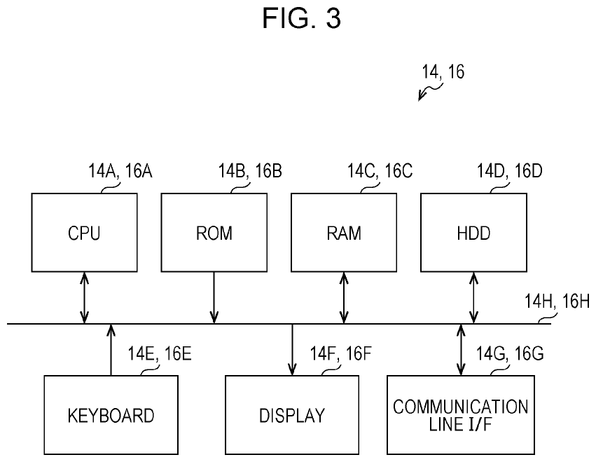

Subsequently, the configuration of the electrical systems of the cloud server 14 for (LGWAN)-(ASP) infrastructure and the EP system 16 according to the exemplary embodiment will be described. FIG. 3 is a block diagram illustrating the configuration of electrical systems of the cloud server 14 for LGWAN-ASP infrastructure and the EP system 16 according to the exemplary embodiment. The cloud server 14 for LGWAN-ASP infrastructure and the EP system 16 according to the exemplary embodiment basically provide the configuration of a general computer, thus the cloud server 14 for LGWAN-ASP infrastructure will be described herein as a representative configuration.

As illustrated in FIG. 3, the cloud server 14 for LGWAN-ASP infrastructure according to the exemplary embodiment includes a CPU 14A, a ROM 14B, a RAM 14C, a HDD 14D, a keyboard 14E, a display 14F, and a communication interface (IF) 14G. The CPU 14A supervises the entire operation of the cloud server 14 for LGWAN-ASP infrastructure. The ROM 14B pre-stores various control programs and various parameters. The RAM 14C is used as a work area or the like when various programs are executed by the CPU 14A. The HDD 14D stores various types of data and application programs. The keyboard 14E is used to input various types of information. The display 14F is used to display various types of information. The communication IF 14G is connected to the LGWAN 18 to transmit and receive various types of data to and from another apparatus connected to the LGWAN 18. The components of the aforementioned cloud server 14 for LGWAN-ASP infrastructure are electrically connected to each other by a system bus 14H. It is to be noted that although the HDD 14D is used as a storage in the cloud server 14 for LGWAN-ASP infrastructure according to the exemplary embodiment, without being limited to this, another non-volatile storage, such as a flash memory, may be used.

With the configuration described above, the cloud server 14 for LGWAN-ASP infrastructure according to the exemplary embodiment performs access to the ROM 14B, the RAM 14C, and the HDD 14D; acquisition of various type of data via the keyboard 14E; and display of various types of information on the display 14F by the CPU 14A. In addition, the cloud server 14 for LGWAN-ASP infrastructure controls the transmission and reception of communication data via the communication line IF 14G by the CPU 14A.

The communication line for the image forming apparatus 12 connected to the LGWAN 18 varies in thickness depending on the local government, thus when a FW is updated, congestion in a communication band and a difficulty in communication work may be caused.

Thus, when distributing a FW to multiple image forming apparatuses 12, the cloud server 14 for LGWAN-ASP infrastructure according to the exemplary embodiment performs processing to distribute the division FW pre-stored in the management DB repository 70 to each of the image forming apparatuses 12 with the FW divided into a distribution number of divisions set for the image forming apparatus 12. Distribution of a FW by the cloud server 14 for LGWAN-ASP infrastructure is performed when distribution conditions, such as a priority and a distribution time, are satisfied. For instance, a FW is distributed in a set distribution time, and when distribution times overlap, the FW is sequentially distributed to an image forming apparatus 12 in descending order of priority.

Subsequently, specific processing performed by each component of the information processing system 10 according to thus configurated exemplary embodiment will be described.

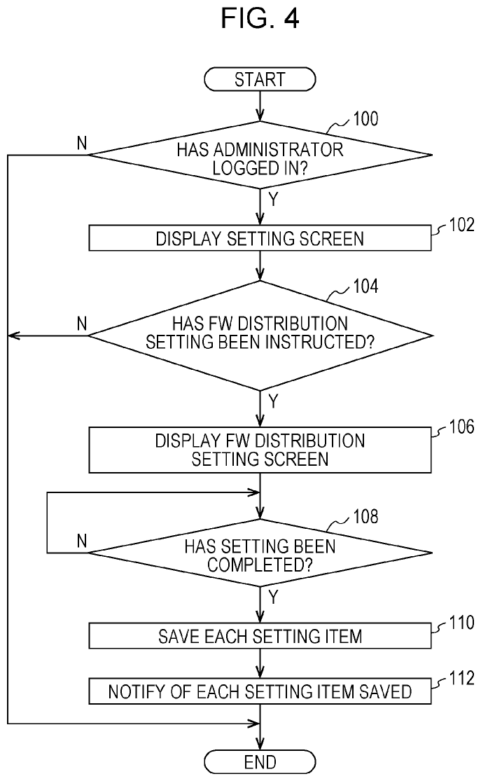

First, specific processing performed at the time distribution setting for an image forming apparatus 12 where FW distribution conditions are settable will be described. FIG. 4 is a flowchart illustrating an example of flow of processing performed at the time distribution setting for the image forming apparatus 12 in the information processing system 10 according to the exemplary embodiment. It is to be noted that the processing of FIG. 4 starts, for instance, when a user logs in the image forming apparatus 12 by well-known authentication such as card authentication.

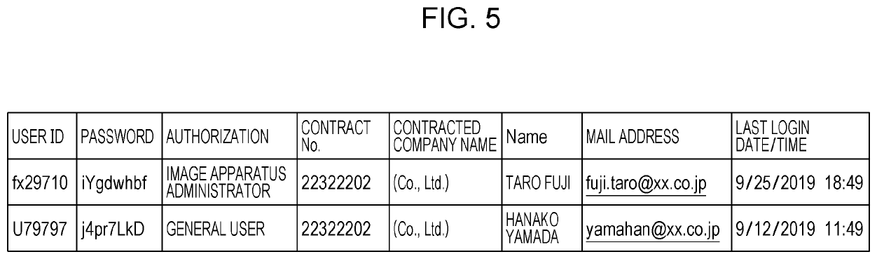

In step 100, the CPU 20A determines whether an administrator has logged in. The determination is made, for instance, by determining whether the login user is the administrator of an image forming apparatus using a pre-registered user management table illustrated in FIG. 5. When negative determination is made, the processing is terminated, and when positive determination is made, the flow proceeds to step 102.

In step 102, the CPU 20A displays a predetermined setting screen for making various settings of the image forming apparatus 12 on a display of the user interface 22, and the flow proceeds to step 104.

In step 104, the CPU 20A determines whether instructions are given for FW distribution setting. The determination is made, for instance, by determining whether an operation is performed to give instructions for distribution setting to a setting screen displayed on a display of the user interface 22. When negative determination is made, the processing is terminated, and when positive determination is made, the flow proceeds to step 106.

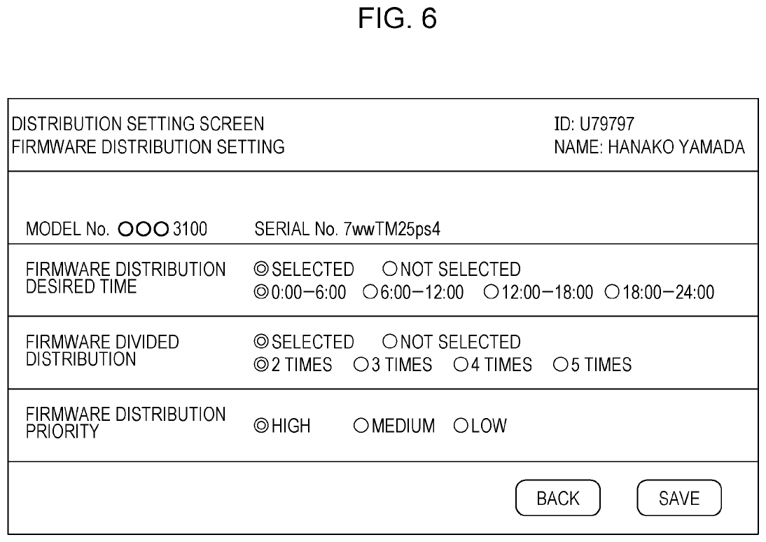

In step 106, the CPU 20A displays a predetermined setting screen, and the flow proceeds to step 108. For instance, the FW distribution setting screen as illustrated in FIG. 6 is displayed as a FW distribution setting screen. The example of FIG. 6 illustrates a FW distribution setting screen by which a FW distribution time, a FW division distribution, and a FW distribution priority can be set.

In step 108, the CPU 20A determines whether setting for the FW distribution setting screen is completed. The determination is made, for instance, by determining whether “SAVE” displayed on the FW distribution setting screen of FIG. 6 is operated. The CPU 20A stays in stand-by until positive determination is made, and the flow proceeds to step 110.

In step 110, the CPU 20A saves each setting item set on the FW distribution setting screen, and the flow proceeds to step 112.

In step 112, the CPU 20A notifies the cloud server 14 for LGWAN-ASP infrastructure of each setting item saved, and completes a series of processing.

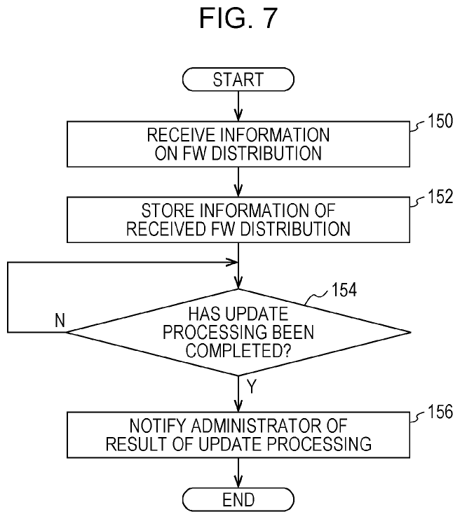

Next, specific processing performed by the cloud server 14 for LGWAN-ASP infrastructure when notification of each setting item is made will be described. FIG. 7 is a flowchart illustrating an example of flow of processing performed when the cloud server 14 for LGWAN-ASP infrastructure in the information processing system 10 according to the exemplary embodiment receives notification of each setting item from the image forming apparatus 12. It is to be noted that the processing of FIG. 7 starts when notification of each setting item is received from the image forming apparatus 12.

In step 150, the CPU 14A receives information on FW distribution notified from the image forming apparatus 12, and the flow proceeds to step 152.

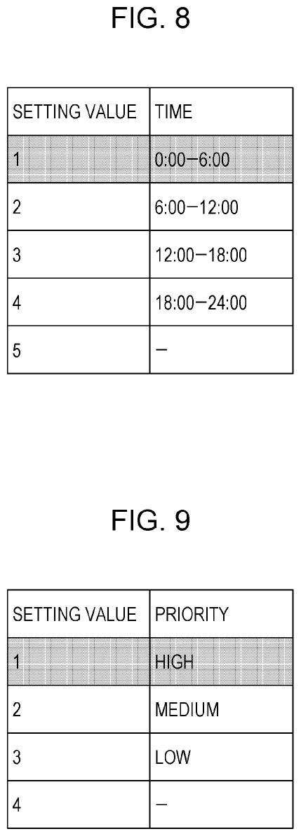

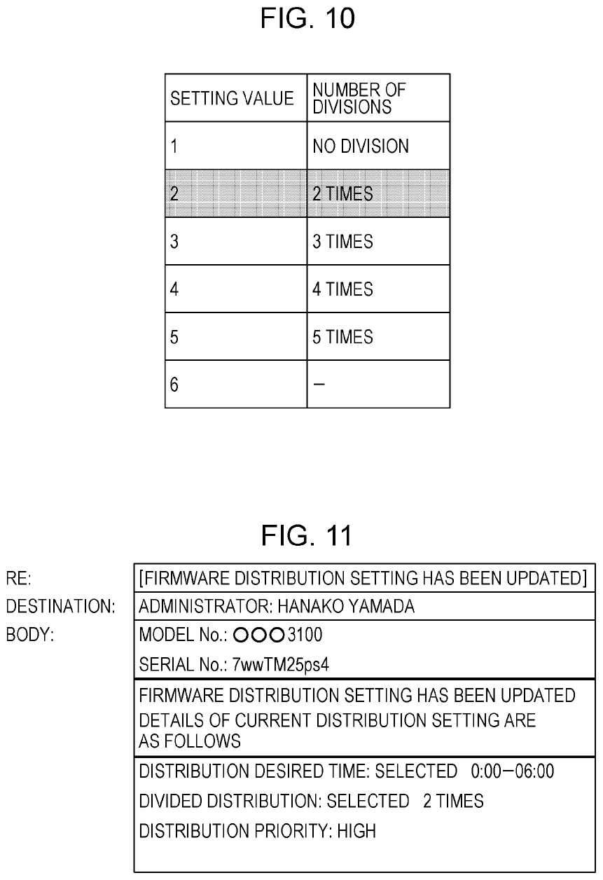

In step 152, the CPU 14A stores the received information on FW distribution in the management DB repository 70, and the flow proceeds to step 154. For instance, for the distribution time, a setting value corresponding to a set distribution time is stored in the management DB repository 70 in association with the image forming apparatus 12 using a predetermined distribution time master illustrated in FIG. 8. For the distribution priority, a setting value corresponding to a set distribution priority is stored in the management DB repository 70 in association with the image forming apparatus 12 using a predetermined distribution priority master illustrated in FIG. 9. For the distribution number of divisions, a setting value corresponding to a set distribution number of divisions is stored in the management DB repository 70 in association with the image forming apparatus 12 using a predetermined distribution division master illustrated in FIG. 10.

In step 154, the CPU 14A determines whether update processing to update the setting for distribution conditions is completed. The determination is made by determining whether storing of the received information on FW distribution in the management DB repository 70 is completed. The CPU 14A stays in stand-by until positive determination is made, and the flow proceeds to step 156.

In step 156, the CPU 14A notifies the administrator of a result of the update processing, and completes a series of processing. For instance, the CPU 14A notifies to the image forming apparatus of the administrator using an e-mail or the like that the FW distribution setting has been updated. As details of notification, for instance, the details of notification illustrated in FIG. 11 are transmitted. The example of FIG. 11 illustrates a model No., a serial No., and details of update of FW.

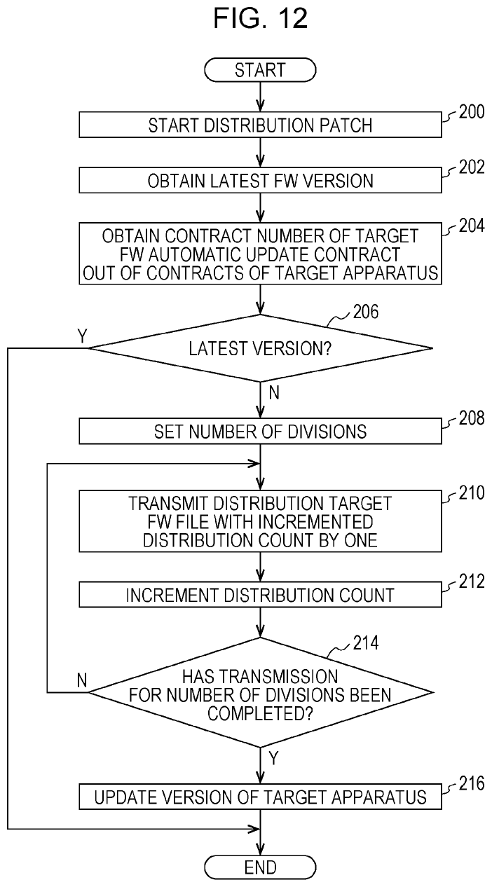

Subsequently, specific processing when the cloud server 14 for LGWAN-ASP infrastructure distributes a FW will be described. FIG. 12 is a flowchart illustrating an example of flow of processing performed when the cloud server 14 for LGWAN-ASP infrastructure in the information processing system 10 according to the exemplary embodiment distributes a FW to the image forming apparatus 12. It is to be noted that the processing of FIG. 12 starts at a distribution time for each image forming apparatus 12, stored in the management DB repository 70, for instance. As an example, a case will be described in which distribution is performed with a model “◯◯◯3100”, a distribution time at “0:00”, and a priority of “high”.

In step 200, the CPU 14A starts a FW distribution patch for the image forming apparatus 12 with a model “◯◯◯3100”, and the flow proceeds to step 202. It is to be noted that for instance, when a FW distribution patch is to start for multiple image forming apparatuses 12 at a distribution time, the CPU 14A starts the FW distribution patch for the image forming apparatuses 12 in descending order of priority.

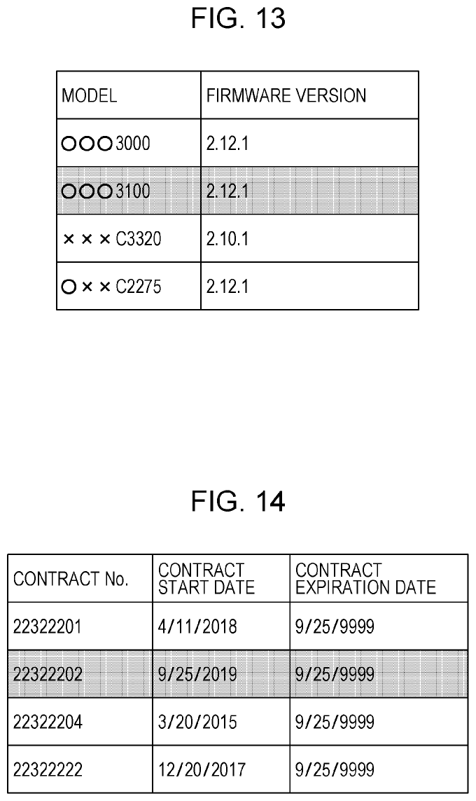

In step 202, the CPU 14A obtains the latest FW version, and the flow proceeds to step 204. For instance, the CPU 14A reads the FW latest version master illustrated in FIG. 13 from the management DB repository 70, and obtains the latest FW version. In FIG. 13, the image forming apparatus 12 with a model “◯◯◯3100” is illustrated in gray.

In step 204, the CPU 14A obtains a contract number of a target FW automatic update contract out of the contracts of target apparatuses which are target image forming apparatuses, and the flow proceeds to step 206. For instance, the CPU 14A obtains a contract number of a target FW automatic update contract from the contract information pre-stored in the management DB repository 70. As an example, as illustrated in FIG. 14, the CPU 14A obtains a contract number from target FW automatic contracts for ◯◯◯3100. The example of FIG. 14 illustrates an instance in gray, in which the contract number of contact No. “22322202” is obtained.

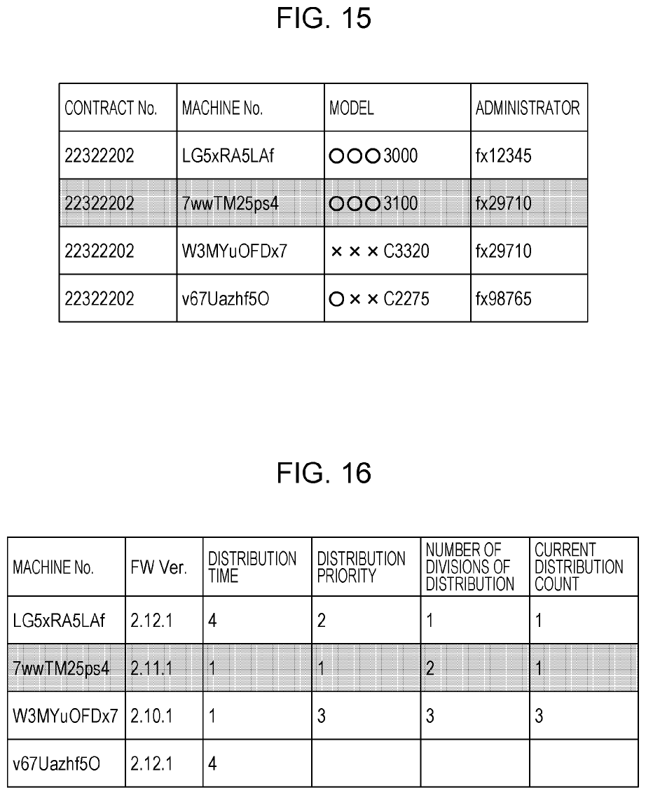

In step 206, the CPU 14A determines whether the target apparatus is the latest version. For instance, a contract/machine table illustrated in FIG. 15 and a machine distribution setting table illustrated in FIG. 16 are stored as the contract information of the management DB repository. Then, the machine number (the machine No. of FIG. 15) corresponding to the contact number (the contact No. of FIG. 15) is identified from the contract/machine table, a corresponding FW version (FW Ver. of FIG. 16) is obtained from the machine distribution setting table, and it is determined whether the obtained FW version is the latest version. When positive determination is made, a series of processing is completed, and when negative determination is made, the flow proceeds to step 208.

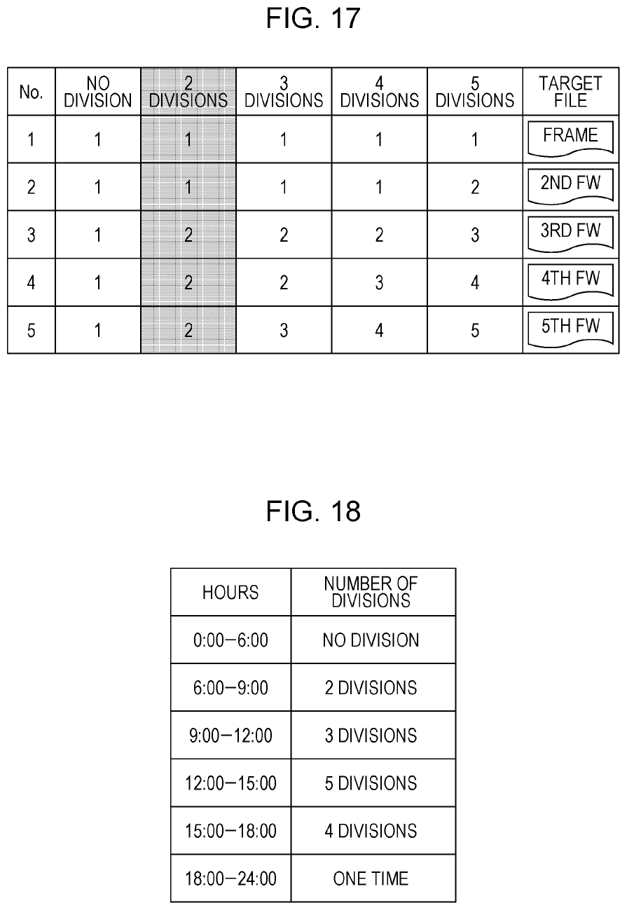

In step 208, the CPU 14A sets the number of divisions to distribute a FW, and the flow proceeds to step 210. For instance, the CPU 14A reads the setting value of the number of divisions for a target apparatus, stored in the management DB repository 70, and sets the number of divisions. In addition, the CPU 14A determines a target file to be distributed according to the number of divisions using the FW repository management master illustrated in FIG. 17. In the example of FIG. 17, a case of distribution with 2 divisions is illustrated in gray. In this case, the frame of the FW and the 2nd FW are distributed in the first distribution, and the 3rd FW, the 4th FW, and the 5th FW are distributed in the second distribution.

In step 210, the CPU 14A transmits a FW file to be distributed with a distribution count increment by 1. For instance, when the distribution count is 0, the CPU 14A reads a target file (the frame and the 2nd FW in the example of FIG. 17) from the firmware DB repository 72, the target file corresponding to 1 in the FW repository management master, and transmits the target file to a target image forming apparatus 12. When the distribution count is 1, the CPU 14A reads a target file (the 3rd FW, the 4th FW, and the 5th FW in the example of FIG. 17) from the firmware DB repository 72, the target file corresponding to 2 in the FW repository management master, and transmits the target file to a target image forming apparatus 12.

In step 212, the CPU 14A increments the distribution count, and the flow proceeds to step 214.

In step 214, the CPU 14A determines whether transmission for the number of divisions has been completed. When negative determination is made, the flow returns to step 210, and the above-described processing is repeated, and when positive determination is made, the flow proceeds to step 216.

In step 216, the CPU 14A updates the version of the FW of the target apparatus, and completes a series of processing. Specifically, the CPU 14A updates the FW latest version management master illustrated in FIG. 13, and stores it in the management DB repository 70.

In this manner, the cloud server 14 for (LGWAN)-(ASP) infrastructure divides and distributes the FW, thus the band occupied when pieces of division FW are distributed for one time is reduced, as compared with when the FW is collectively distributed.

Although an example has been described, in which the number of divisions of the FW is pre-set in the image forming apparatus 12 in the above-described exemplary embodiment, this is not always the case. For instance, the number of divisions may be determined by the interval of the distribution time. Alternatively, a response time corresponding to each band in the communication network is measured, and the number of pieces of division FW to be transmitted for one time may be determined. Alternatively, the number of divisions may be changed according to a priority.

As an example of determining the number of divisions for distribution by the distribution time, for instance, as illustrated in FIG. 18, the number of divisions for each distribution time is pre-determined, and the number of divisions defined for each distribution time may be read and set. In the example of FIG. 18, when the time for distribution of FW is 0:00 to 6:00 and 18:00 to 24:00, the FW is collectively distributed. An example of a number of divisions setting table is illustrated, in which distribution is performed with 2 divisions for 6:00 to 9:00, 3 divisions for 9:00 to 12:00, 5 divisions for 12:00 to 15:00, and 4 divisions for 15:00 to 18:00. The number of divisions for each time may be determined by pre-measuring each band.

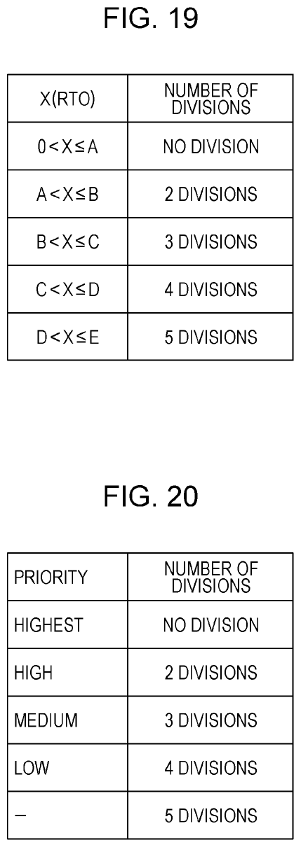

In addition, as an example of measuring a response time corresponding to each band in the communication network, and determining the number of pieces of division FW to be transmitted for one time, for instance, as illustrated in FIG. 19, a retransmission time out (RTO) at the time of FW distribution is measured as an example of a response time. The number of divisions is predetermined for every RTO, and the number of divisions corresponding to a result of measurement may be read and set. In the example of FIG. 19, an example of the number of divisions setting table is illustrated, in which X is the RTO, and distribution is performed collectively for the range of 0<X≤A, with 2 divisions for the range of A<X≤B, with 3 divisions for the range of B<X≤C, with 4 divisions for the range of C<X≤D, and with 5 divisions for the range of D<X≤E, where 0<A<B<C<D<E.

In addition, as an example of changing the number of divisions according to a priority, for instance, as illustrated in FIG. 20, the number of divisions according to a priority is pre-determined, and the number of divisions corresponding to a FW distribution priority set for each image forming apparatus 12 may be read and set. In the example of FIG. 20, an example of the number of divisions setting table is illustrated, in which distribution is performed collectively for the case of a highest priority, with 2 divisions for the case of a high priority, with 3 divisions for the case of a medium priority, with 4 divisions for the case of a low priority, and with 5 divisions for the case of no priority setting.

In the exemplary embodiment, an example has been described, in which FW distribution conditions are set by the image forming apparatus 12. However, this is not always the case. For instance, FW distribution conditions may be set by other apparatuses, such as the cloud server 14 for (LGWAN)-(ASP) infrastructure, the information processing terminal of the administrator of the image forming apparatus 12, and the information processing terminal 64 of an EP administrator.

In the exemplary embodiment, the LGWAN has been described as an example of a communication network. However, the communication network is not limited to the LGWAN, and other WAN or LAN may be used as a communication network.

In the exemplary embodiment, FW distribution of the image forming apparatus 12 has been described as an example. However, without being limited to the image forming apparatus 12, the present disclosure is applicable to FW distribution of other apparatuses.

In the exemplary embodiment, the cloud server 14 for (LGWAN)-(ASP) infrastructure and the EP system 16 have been described as individual components. However, without being limited to this, the cloud server 14 for (LGWAN)-(ASP) infrastructure and the EP system 16 may form one system.

In the exemplary embodiment above, the CPU has been described as an example of a processor, and the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The processing performed by each component of the information processing system 10 according to the exemplary embodiment may be performed by software, may be performed by hardware, or may be performed by a combination of software and hardware. In addition, the processing performed by each component of the information processing system 10 may be stored in a recording medium as a program, and distributed.

The present disclosure is not limited to the above described, and in addition to the above described, the present disclosure may be modified in various ways and implemented within a range not departing from the spirit of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
upon distribution of a firmware to a plurality of target apparatuses connected to a predetermined communication network, divide in advance and hold the firmware into a predetermined number of pieces of divided firmware; and
distribute the pieces of divided firmware to each of the plurality of target apparatuses with the pieces divided into distribution number of divisions set for the target apparatus.

2. The information processing apparatus according to claim 1, wherein the processor obtains a distribution condition including the distribution number of divisions from the target apparatus for which the distribution number of divisions is settable.

3. The information processing apparatus according to claim 1, wherein the processor obtains, from the target apparatus for which a distribution time is settable, a distribution condition including the distribution time, and performs processing to distribute pieces of divided firmware in the obtained distribution time.

4. The information processing apparatus according to claim 2, wherein the processor obtains, from the target apparatus for which a distribution time is settable, a distribution condition including the distribution time, and performs processing to distribute pieces of divided firmware in the obtained distribution time.

5. The information processing apparatus according to claim 1, wherein the processor distributes the pieces of divided firmware with the pieces divided into the distribution number of divisions which is predetermined according to band information for a band of the communication network.

6. The information processing apparatus according to claim 5, wherein the processor distributes the pieces of divided firmware with the pieces divided into the distribution number of divisions which is predetermined as the band information for each time in which the firmware is distributed.

7. The information processing apparatus according to claim 5, wherein the processor measures a response time as the band information, the response time corresponding to the band of the communication network when the firmware is distributed, and distributes the pieces of divided firmware with the pieces divided into the distribution number of divisions which is predetermined for the measured response time.

8. The information processing apparatus according to claim 1, wherein the processor obtains, from the target apparatus for which a priority of distribution of the firmware is settable, a distribution condition including the priority, and distributes the pieces of divided firmware using the priority.

9. The information processing apparatus according to claim 2, wherein the processor obtains, from the target apparatus for which a priority of distribution of the firmware is settable, a distribution condition including the priority, and distributes the pieces of divided firmware using the priority.

10. The information processing apparatus according to claim 3, wherein the processor obtains, from the target apparatus for which a priority of distribution of the firmware is settable, a distribution condition including the priority, and distributes the pieces of divided firmware using the priority.

11. The information processing apparatus according to claim 4, wherein the processor obtains, from the target apparatus for which a priority of distribution of the firmware is settable, a distribution condition including the priority, and distributes the pieces of divided firmware using the priority.

12. The information processing apparatus according to claim 5, wherein the processor obtains, from the target apparatus for which a priority of distribution of the firmware is settable, a distribution condition including the priority, and distributes the pieces of divided firmware using the priority.

13. The information processing apparatus according to claim 6, wherein the processor obtains, from the target apparatus for which a priority of distribution of the firmware is settable, a distribution condition including the priority, and distributes the pieces of divided firmware using the priority.

14. The information processing apparatus according to claim 7, wherein the processor obtains, from the target apparatus for which a priority of distribution of the firmware is settable, a distribution condition including the priority, and distributes the pieces of divided firmware using the priority.

15. The information processing apparatus according to claim 8, wherein the processor performs processing to distribute the pieces of divided firmware in descending order of the priority of the target apparatus.

16. The information processing apparatus according to claim 9, wherein the processor performs processing to distribute the pieces of divided firmware in descending order of the priority of the target apparatus.

17. The information processing apparatus according to claim 10, wherein the processor performs processing to distribute the pieces of divided firmware in descending order of the priority of the target apparatus.

18. The information processing apparatus according to claim 8, wherein the processor distributes the pieces of divided firmware with the pieces divided into the distribution number of divisions which is predetermined according to the priority.

19. An information processing system comprising:
the information processing apparatus according to claim 1; and
a target apparatus which is connected to the communication network, and to which a firmware is to be distributed.

20. A non-transitory computer readable medium storing an information processing program causing a computer to execute a process comprising:
upon distribution of a firmware to a plurality of target apparatuses connected to a predetermined communication network, dividing in advance and holding the firmware into a predetermined number of pieces of divided firmware; and
distributing the pieces of divided firmware to each of the plurality of target apparatuses with the pieces divided into distribution number of divisions set for the target apparatus.
